(19) United States
(12) Patent Application Publication
(10) Pub. No.: US 2023/0007954 A1
(43) Pub. Date: Jan. 12, 2023

(54) ACOUSTIC IMPEDANCE MATCHING DEVICES AND RELATED METHODS

(71) Applicant: Baker Hughes Oilfield Operations LLC, Houston, TX (US)

(72) Inventors: Navin Sakthivel, Spring, TX (US); Aaron Avagliano, Tomball, TX (US); Elan Yogeswaren, Houston, TX (US); Nils Neumann, Houston (US); Joshua Snitkoff, Friendswood, TX (US); Mikhail Anisimov, Calgary (CA)

(21) Appl. No.: 17/369,096

(22) Filed: Jul. 7, 2021

(51) Int. Cl. G10K 11/02; H04R 3/02

(52) U.S. Cl. CPC G10K 11/02; H04R 3/02

(57) ABSTRACT

Acoustic impedance matching devices and related methods are disclosed. An acoustic impedance matching device includes a first face for facing an acoustic transducer, a second face opposite the first face, and a lattice structure between the first face and the second face. The second is face curved to at least substantially conformally engage an inner surface of a tubing. An effective acoustic impedance of the lattice structure substantially matches a transducer acoustic impedance of the acoustic transducer to a tubing acoustic impedance of the tubing. A material acoustic impedance of a material of the lattice structure is greater than the effective acoustic impedance. A method of manufacturing an acoustic impedance matching device includes providing, to an additive manufacturing apparatus, a digital design defining the lattice structure, providing an additive manufacturing material to a material intake of the additive manufacturing apparatus, and manufacturing the lattice structure using the additive manufacturing material.

### TECHNICAL FIELD

This disclosure relates generally to acoustic impedance matching devices, and more specifically to matching acoustic impedances of acoustic transducers to steel tubing in wellbores.

### BACKGROUND

Wells (e.g., oil wells, natural gas wells, etc.) may be used to extract valuable materials (e.g., oil, gas, minerals, etc.) from the earth. Once the valuable materials have been extracted it may be desirable to abandon a depleted well. Before abandoning a well, however, the well may be sealed to reduce the chances that an animal or a person will fall into the well, and/or to reduce the chances that harmful materials will exit the well and contaminate the environment and/or other resources (e.g., water, farmland, etc.) around the well.

### BRIEF SUMMARY

In some embodiments an acoustic impedance matching device includes a first face for facing an acoustic transducer, a second face opposite the first face, and a lattice structure between the first face and the second face. The second face is shaped to at least substantially conformally engage an inner surface of a tubing. An effective acoustic impedance of the lattice structure substantially matches a transducer acoustic impedance of the acoustic transducer to a tubing acoustic impedance of the tubing. A material acoustic impedance of a material of the lattice structure is greater than the effective acoustic impedance.

In some embodiments a method of manufacturing an acoustic impedance matching device includes providing computer-readable instructions to a controller of an additive manufacturing apparatus. The computer-readable instructions are configured to instruct the controller to manufacture the acoustic impedance matching device according to a digital design of the acoustic impedance matching device. The digital design defines a lattice structure including a first face for facing an acoustic transducer and a second face to conformally engage an inner surface of a tubing. The acoustic impedance matching device is designed to manifest an effective acoustic impedance from the first face to the second face that matches a transducer acoustic impedance of the acoustic transducer to a tubing acoustic impedance of the tubing. The method also includes providing an additive manufacturing material to a material intake of the additive manufacturing apparatus. The additive manufacturing material has a material acoustic impedance that is greater than the effective acoustic impedance. The method further includes manufacturing, with the additive manufacturing apparatus and according to the machine-readable instructions, the lattice structure using the additive manufacturing material.

In some embodiments a method of operating an acoustic impedance matching device includes applying an acoustic transducer to a first face of an acoustic impedance matching device. The acoustic transducer has a transducer acoustic impedance. The method also includes placing a second face of the acoustic impedance matching device into contact with an internal surface of a tubing. The second face is opposite to the first face. The tubing has a tubing acoustic impedance that is mismatched to the transducer acoustic impedance. The method further includes at least substantially matching the transducer acoustic impedance to the tubing acoustic impedance with an effective acoustic impedance of the acoustic impedance matching device that is less than a material acoustic impedance of a material of the acoustic impedance matching device. A lattice structure of the material of the acoustic impedance matching device reduces the effective acoustic impedance of the acoustic impedance matching device relative to the material acoustic impedance. The method also includes transmitting an acoustic signal from the acoustic transducer to a casing through the acoustic impedance matching device and the tubing, receiving a reflected acoustic signal, and determining one or more properties of the casing responsive to the reflected acoustic signal.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a perspective view of a well, according to some embodiments;

FIG. 2 is a top view of a well segment, according to some embodiments;

FIG. 3A is a perspective view of an acoustic impedance matching device having a honeycomb lattice structure, according to some embodiments;

FIG. 3B is a front face view of the acoustic impedance matching device 300 of FIG. 3A;

FIG. 3C is a cross-sectional view of the acoustic impedance matching device of FIG. 3A and FIG. 3B;

FIG. 4 is a flowchart illustrating a method of operating an acoustic impedance matching device, according to some embodiments;

FIG. 5 is a block diagram of an additive manufacturing apparatus, according to some embodiments;

FIG. 6 is a flowchart illustrating a method of manufacturing an acoustic impedance matching device, according to some embodiments; and

FIG. 7 is a block diagram of circuitry that, in some embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Casing inspection of wells (e.g., oil wells) may be performed to determine whether it is safe to seal and abandon the wells. For example, if a casing and/or a tubing within a well is damaged, capping a top of the well may not prevent pollutants from escaping the well. High frequency acoustics may be used to measure the strength and condition of a steel casing or liner, or other permanent tubular element cemented within a well before a well is plugged and abandoned.

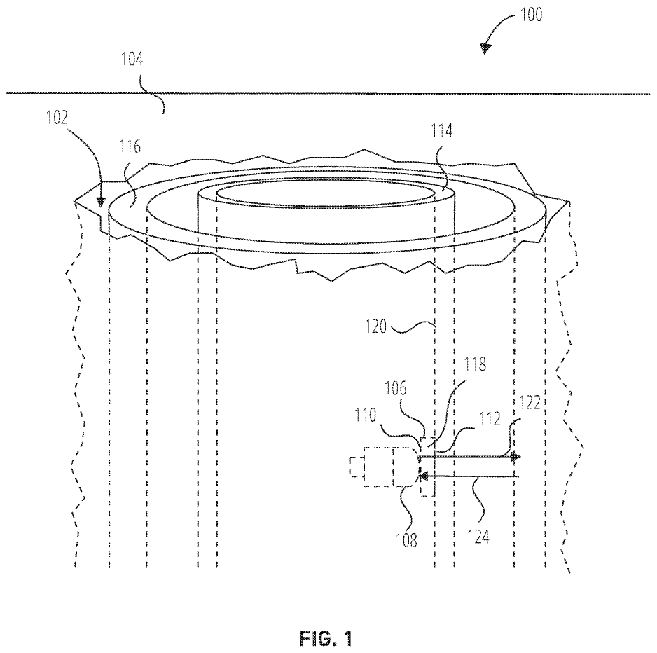

FIG. 1 is a perspective view of a portion of an example well 100. The well 100 includes a wellbore 102 formed into a formation 104, a casing 116 (such term also encompassing a liner) within the wellbore 102, and a tubing 114 within the casing 116. In some embodiments the casing 116 includes a cement envelope surrounding the casing 116 between the casing exterior and the surrounding wall of the wellbore 102. In some embodiments the tubing 114 includes a metal tubing (e.g., a steel tubing). In some embodiments the tubing 114 includes a polymer tubing.

As discussed above, it may be desirable to inspect the well 100. By way of non-limiting example, it may be desirable to inspect the well 100 before sealing and abandoning the well 100. It will be appreciated by those of ordinary skill in the art, however, that it may also be desirable to inspect the well 100 at any time before, during or after use of the well 100 for the production of hydrocarbons or minerals in solution. FIG. 1 illustrates an acoustic transducer 108 that may be used to inspect the well 100. The acoustic transducer 108 is configured to transmit an acoustic signal 122 to the tubing 114 and receive a reflected acoustic signal 124 responsive to the acoustic signal 122.

In some embodiments the acoustic transducer 108 may include a piezo crystal, which may have a transducer acoustic impedance of substantially 15 to 20 megaRayl (MRayl). By contrast, a tubing acoustic impedance of the tubing 114, assuming that the tubing 114 is a steel tubing, may be substantially 40 to 44 MRayl. Accordingly, an acoustic impedance mismatch between the acoustic transducer 108 and the tubing 114 may exist. This acoustic impedance mismatch may cause the acoustic signal 122 to attenuate by substantially 20 to 30 decibels (dB) by the time the acoustic signal 122 reaches the casing 116. The acoustic impedance mismatch may also cause the reflected acoustic signal 124 to attenuate by substantially 20 to 30 dB by the time the reflected acoustic signal 124 reaches the acoustic transducer 108. As a result, the reflected acoustic signal 124 received by the acoustic transducer 108 may be attenuated by up to 60 dB as compared to the acoustic signal 122 that is provided by the acoustic transducer 108, which may drop the reflected acoustic signal 124 below a noise floor, in some instances. Given this acoustic impedance mismatch, it may be difficult to obtain useful, relevant information about the integrity of the casing 116 using the acoustic transducer 108 if the acoustic transducer 108 is applied directly to the tubing 114.

FIG. 1, however, illustrates that an acoustic impedance matching device 106 may be used to substantially match the transducer acoustic impedance of the acoustic transducer 108 to the tubing acoustic impedance of the tubing 114. The acoustic impedance matching device 106 may serve as an acoustic cover for the acoustic transducer 108. The acoustic impedance matching device 106 includes a first face for facing the acoustic transducer 108 and a second face 112 opposite the first face 110. The second face 112 is shaped to substantially conformally engage an inner surface 120 of the tubing 114. By way of non-limiting example, the second face 112 may be curved to be conformal to a curvature of the inner surface 120 of the tubing 114, which may be substantially shaped like a hollow cylinder.

An effective acoustic impedance of the acoustic impedance matching device 106 substantially matches the transducer acoustic impedance of the acoustic transducer 108 to the tubing acoustic impedance of the tubing 114. In some embodiments the acoustic impedance matching device 106 may functionally match the transducer acoustic impedance to the tubing acoustic impedance. By way of non-limiting example, an effective acoustic impedance of the acoustic impedance matching device 106 may be substantially the geometric mean of the transducer acoustic impedance and the tubing acoustic impedance. Assuming that the transducer acoustic impedance is 15 to 20 MRayl and the tubing acoustic impedance is 40 to 44 MRayl, an appropriate effective acoustic impedance of the acoustic impedance matching device 106 may be substantially 27 MRayl (e.g., because the geometric mean of 17.5 MRayl and 42 MRayl is substantially 27 MRayl, or sqrt((17.5 MRayl)*(42 MRayl))=substantially 27 MRayl).

Materials that naturally have acoustic impedances substantially equal to 27 MRayl may not be ideal for use in downhole environments such as the well 100 of FIG. 1. For example, certain ceramic materials may have acoustic impedances substantially equal to 27 MRayl, but such ceramic materials may be relatively fragile, and may have a tendency to break while inspecting wells. Titanium also has an acoustic impedance substantially equal to 27 MRayl. Titanium is stronger than ceramics, but is extremely hard and difficult to machine and so may be difficult to work. Also, it may be undesirable to use different materials for acoustic impedance matching devices for different acoustic transducers having different transducer acoustic impedances and/or different tubing having different tubing acoustic impedances.

Rather than using a solid material having an acoustic impedance substantially equal to 27 MRayl, the acoustic impedance matching device 106 may include a lattice structure 118 between the first face 110 and the second face 112. A material acoustic impedance of a material of the lattice structure 118 may be greater than the effective acoustic impedance of the acoustic impedance matching device 106. Since features of the material of the lattice structure 118 define gaps therebetween, the effective acoustic impedance of the lattice structure 118 may be reduced as compared to the material acoustic impedance of the solid material. By way of non-limiting example, the material may include a metal. As a specific, non-limiting example, the material may include a nickel-chromium-based alloy such as Inconel® 718, which has a material acoustic impedance of substantially 40 MRayl. The effective acoustic impedance of the lattice structure 118 may be reduced due to the gaps in the lattice structure 118 from substantially 40 MRayl to substantially 27 MRayl. In some embodiments the gaps between the structures of the material within the lattice structure 118 may be filled with a filler material (e.g., oil, epoxy) to reduce or prevent scattering of acoustic waves.

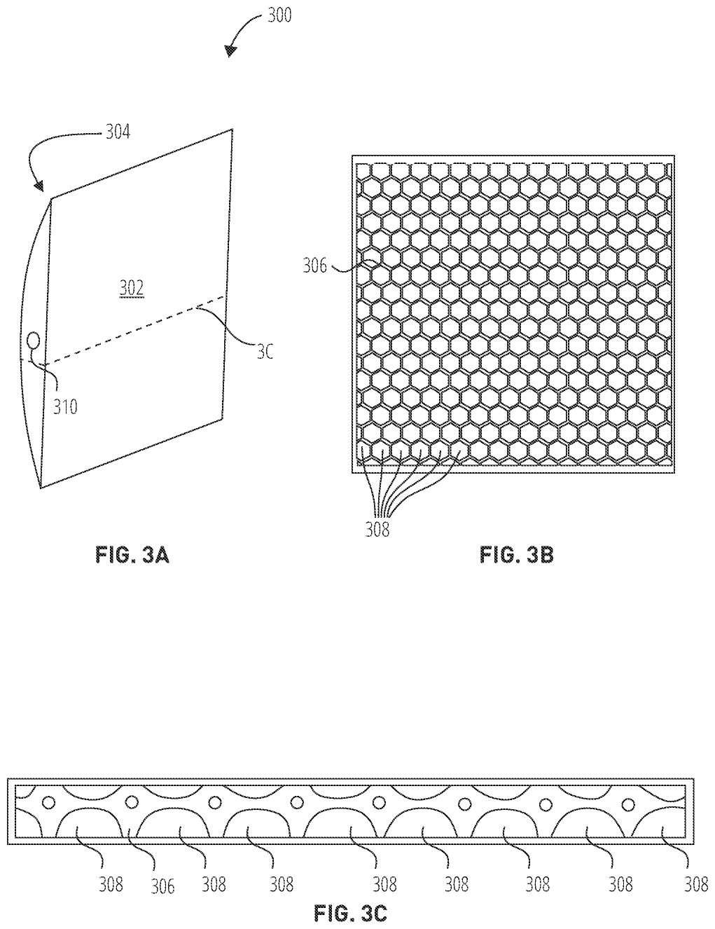

In some embodiments the lattice structure 118 includes a honeycomb lattice structure, such as a honeycomb lattice structure 306 discussed with reference to FIG. 3B and FIG. 3C. In some embodiments the lattice structure 118 is one or more of a cubic lattice structure, a square lattice structure, a triangular lattice structure, an octet-truss lattice structure, a Kelvin cell lattice structure, a circular lattice structure, an octagonal lattice structure, a pyramidal lattice structure, a diamond lattice structure, a gyroid lattice structure, a Schwarz minimal surface lattice structure, or a Neovius surface lattice structure, other lattice structures, or combinations thereof. In some embodiments a density of the lattice structure may increase from the first face 110 to the second face 112.

Since the effective acoustic impedance of the lattice structure 118 may be designed into the lattice structure 118, any effective acoustic impedance that is less than or equal to the material acoustic impedance may be designed into the lattice structure 118. As a result, relatively strong, durable materials may be used and a wide variety of effective acoustic impedances may be achieved using the same material. Also, the use of materials for the lattice structure 118 that naturally have a desired acoustic impedance may not be required. Rather, any available material (e.g., metal alloy) may be used to manufacture the lattice structure 118.

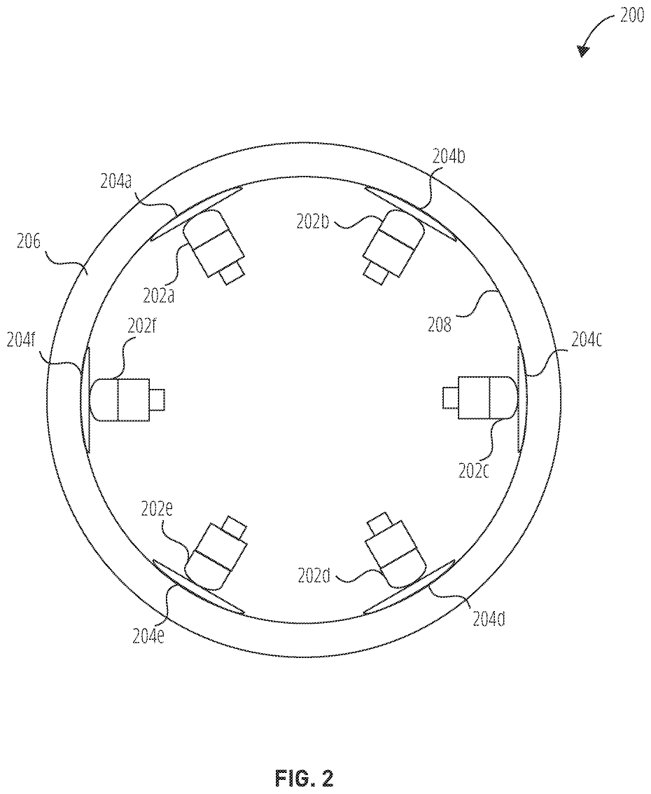

FIG. 2 is a top view of a well segment 200, according to some embodiments. The well segment 200 includes a tubing 206 similar to the tubing 114 of FIG. 1. Although not illustrated in FIG. 2, a casing cemented into the well segment 200 similar to the casing 116 of FIG. 1 may be used, and the tubing 206 may be deployed within the casing.

FIG. 2 illustrates multiple acoustic transducers 202a, 202b, 202c, 202d, 202e, and 202f deployed within the tubing 206. Each of the acoustic transducers 202a, 202b, 202c, 202d, 202e, and 202f has one of multiple acoustic impedance matching devices 204a, 204b, 204c, 204d, 204e, and 204f disposed between itself and an internal surface 208 of the tubing 206. As illustrated in FIG. 2, second surfaces of the acoustic impedance matching devices 204a, 204b, 204c, 204d, 204e, and 204f are curved to conform to a curvature of the internal surface 208 of the tubing 206.

Since multiple acoustic transducers 202a, 202b, 202c, 202d, 202e, and 202f and their corresponding acoustic impedance matching devices 204a, 204b, 204c, 204d, 204e, and 204f are deployed within the tubing 206, information may be obtain for substantially an entire circumference of the tubing 206 and/or a casing (not shown).

FIG. 3A through FIG. 3C are views of an acoustic impedance matching device 300 having a honeycomb lattice structure 306, according to some embodiments. FIG. 3A is a perspective view of the acoustic impedance matching device 300. As illustrated in FIG. 3A, the acoustic impedance matching device 300 includes a first face 302 configured to face an acoustic transducer. The acoustic impedance matching device 300 also includes a second face 304 configured to at least substantially conformally engage with a tubing (e.g., in a well). FIG. 3A also illustrates a drain hole 310, which may be sealed prior to use of the acoustic impedance matching device 300. The drain hole 310 may be used to enable removal of extra material (e.g., an additive manufacturing material such as powder) after manufacturing of the acoustic impedance matching device 300. The drain hole 310 may also enable a filler material (e.g., oil, epoxy) to be added into gaps 308 (FIG. 3B and FIG. 3C) of a honeycomb lattice structure 306 (FIG. 3B and FIG. 3C) of the acoustic impedance matching device 300.

FIG. 3B is a front face view of the acoustic impedance matching device 300 of FIG. 3A. FIG. 3B illustrates the honeycomb lattice structure 306, and the gaps 308 within the honeycomb lattice structure 306. In some embodiments a cover may be placed over the honeycomb lattice structure 306 to form the first face 302. In some embodiments the honeycomb lattice structure 306 may be exposed, and may itself serve as the first face 302.

FIG. 3C is a cross-sectional view of the acoustic impedance matching device 300 of FIG. 3A taken through cross-section 3C of FIG. 3A. FIG. 3C illustrates the honeycomb lattice structure 306 and the gaps 308 within the honeycomb lattice structure 306. An amount of the lattice spacing, or free volume of the gaps 308, may be determined based, at least in part, on a density of the material of the honeycomb lattice structure 306. The acoustic impedance Z may be determined as Z=pc, where p is the density of the material and c is the speed of sound. Accordingly, to decrease the density, and in turn the acoustic impedance of the honeycomb lattice structure 306, the total volume of the gaps 308 may be increased. Accordingly, the volumes of the honeycomb lattice structure 306 that are occupied by material and the gaps 308 may be selected such that the resulting density p yields an effective acoustic impedance of the acoustic impedance matching device 300 that corresponds to the geometric mean between a transducer acoustic impedance and a tubing acoustic impedance.

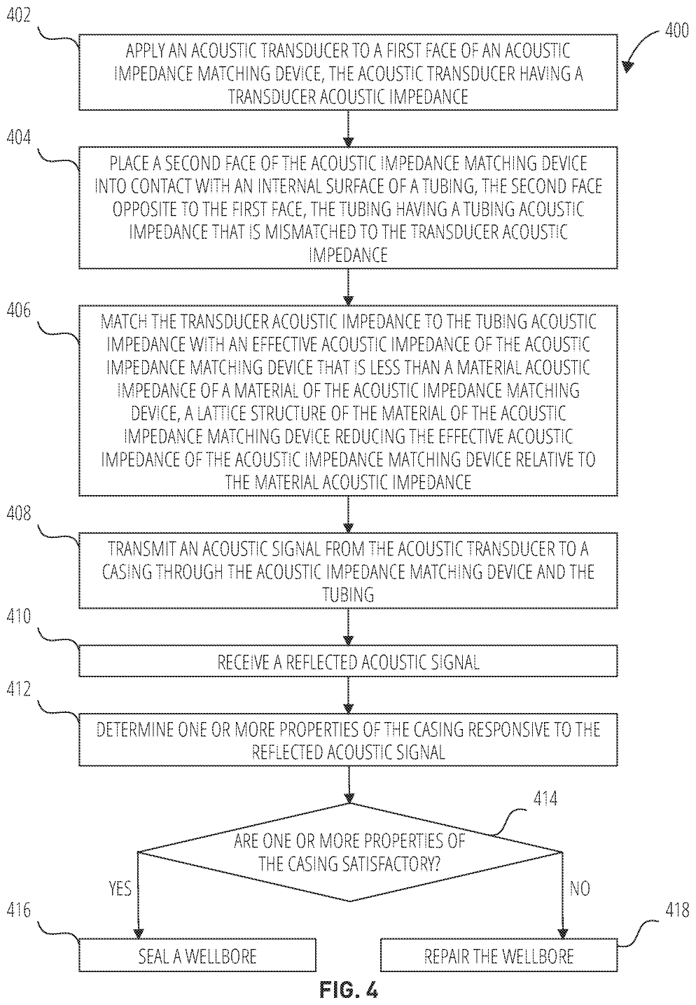

FIG. 4 is a flowchart illustrating a method 400 of operating an acoustic impedance matching device, according to some embodiments. At operation 402 the method 400 includes applying an acoustic transducer to a first face of an acoustic impedance matching device. The acoustic transducer has a transducer acoustic impedance. In some embodiments applying the acoustic transducer to the first face of the acoustic impedance matching device includes applying a piezo crystal having the transducer acoustic impedance of substantially 15 to 20 MRayl to the first face of the acoustic impedance matching device.

At operation 404 the method 400 includes placing a second face of the acoustic impedance matching device into contact with an internal surface of a tubing. The second face is opposite to the first face. The tubing has a tubing acoustic impedance that is mismatched to the transducer acoustic impedance. In some embodiments placing the second face of the acoustic impedance matching device into contact with the internal surface of the tubing includes placing the second face of the acoustic impedance matching device into contact with the internal surface of a metal tubing. In some embodiments placing the second face of the acoustic impedance matching device into contact with the internal surface of the tubing includes placing the second face of the acoustic impedance matching device into contact with the internal surface of a steel tubing. In some embodiments placing the second face of the acoustic impedance matching device into contact with the internal surface of the tubing includes placing the second face of the acoustic impedance matching device into contact with the internal surface of a polymer tubing.

At operation 406 the method 400 includes matching the transducer acoustic impedance to the tubing acoustic impedance with an effective acoustic impedance of the acoustic impedance matching device that is less than a material acoustic impedance of a material of the acoustic impedance matching device. A lattice structure of the material of the acoustic impedance matching device reduces the effective acoustic impedance of the acoustic impedance matching device relative to the material acoustic impedance.

At operation 408 the method 400 includes transmitting an acoustic signal from the acoustic transducer to a casing through the acoustic impedance matching device and the tubing. In some embodiments transmitting the acoustic signal from the acoustic transducer to the casing through the acoustic impedance matching device and the tubing includes transmitting the acoustic signal to a casing cemented in the wellbore through the acoustic impedance matching device and a steel tubing.

At operation 410 the method 400 includes receiving a reflected acoustic signal. At operation 412 the method 400 includes determining one or more properties of the casing responsive to the reflected acoustic signal. At decision 414 the method includes determining whether the one or more properties of the casing are satisfactory. At operation 416 the method 400 includes sealing a wellbore responsive to a determination that the one or more properties of the casing are satisfactory. At operation 418 the method 400 includes repairing the wellbore responsive to a determination that the one or more properties of the casing are not satisfactory.

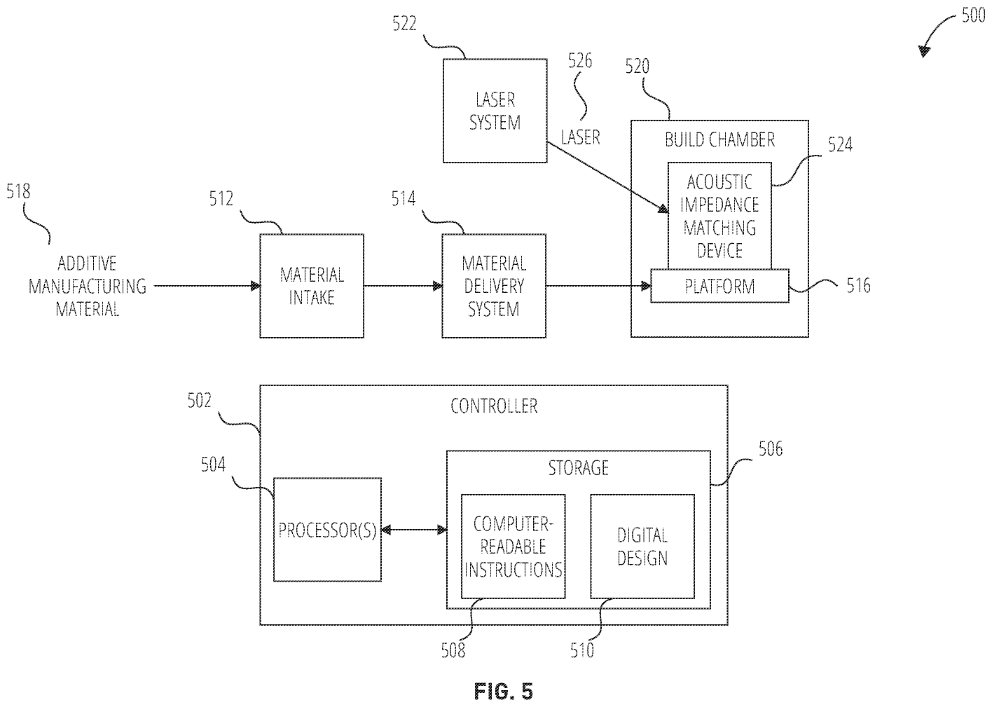

FIG. 5 is a block diagram of an additive manufacturing apparatus 500, according to some embodiments. It may be relatively difficult, and may even be cost prohibitive, to machine a complex lattice structure from, for example, a metal workpiece to form an impedance matching device according to embodiments disclosed herein. As a result, in some embodiments a lattice structure (e.g., the lattice structure 118 of FIG. 1, the honeycomb lattice structure 306 of FIG. 3B and FIG. 3C) of an impedance matching device (e.g., the acoustic impedance matching device 106 of FIG. 1, the acoustic impedance matching device 300 of FIG. 3A, FIG. 3B, and FIG. 3C) may be manufactured using an additive manufacturing apparatus such as the additive manufacturing apparatus 500 of FIG. 5.

The additive manufacturing apparatus 500 includes a material intake 512, a material delivery system 514, a laser system 522, a build chamber 520, and a controller 502. The build chamber 520 includes a platform 516 for manufacturing an acoustic impedance matching device 524 thereon. The controller 502 includes one or more processors 504 and one or more data storage devices 506.

The material intake 512 is configured to receive a particulate or otherwise flowable additive manufacturing material 518 and deliver the additive manufacturing material 518 to a material delivery system 514. The material delivery system 514 is configured to deliver the additive manufacturing material 518 to the platform 516, and the laser system 522 is configured to cure or otherwise bond the additive manufacturing material 518 at the platform 516 into a desired structural configuration for an impedance matching device 524.

The controller 502 is configured to control operation of the additive manufacturing apparatus 500. For example, the controller 502 may control the material intake 512, the material delivery system 514, the laser system 522, or combinations thereof. The data storage devices 506 includes computer-readable instructions 508 and a digital design 510 of the acoustic impedance matching device 524 stored thereon. The computer-readable instructions 508 are configured to instruct the computer-readable instructions 508 to manufacture the acoustic impedance matching device 524 according to the digital design 510.

The digital design 510 defines a lattice structure of the acoustic impedance matching device 524 including a first face for facing an acoustic transducer and a second face to at least substantially conformally engage an inner surface of a tubing. As discussed above, the acoustic impedance matching device 524 defined by the digital design 510 is designed to manifest an effective acoustic impedance from the first face to the second face that matches a transducer acoustic impedance of an acoustic transducer to a tubing acoustic impedance of a tubing.

In some embodiments the digital design 510 may define drain holes (e.g., the drain hole 310 of FIG. 3A) in the acoustic impedance matching device 524. After manufacturing of the acoustic impedance matching device 524, the acoustic impedance matching device 524 may be saw cut from the platform 516 (e.g., a build plate) and may be tumbled to remove burrs. Any additive manufacturing material 518 (e.g., powder) trapped within the acoustic impedance matching device 524 may be removed through the drain holes. Also, a filler material (e.g., oil, epoxy) may be provided into the acoustic impedance matching device 524 through the drain holes to reduce or prevent unwanted scattering of acoustic waves. The drain holes may be plugged using sealants.

In some embodiments the acoustic impedance matching device 524 may be lattice structured using latticing computer aided design (CAD) software. In some such embodiments the computer-readable instructions 508 may include latticing CAD software.

Any of a variety of additive manufacturing processes may be used to manufacture the acoustic impedance matching device 524. In some embodiments a powder-bed fusion additive manufacturing process may be used to manufacture the acoustic impedance matching device 524. Powder-bed fusion additive manufacturing typically provides relatively high resolution manufacturing, which may enable manufacturing of relatively complex lattice structures for the acoustic impedance matching device 524. Other additive manufacturing processes, however, may also be used. By way of non-limiting examples, binder jetting, directed energy deposition, sheet lamination, material extrusion, material jetting, vat photo polymerization, other additive manufacturing processes, or combinations thereof may be used.

The use of additive manufacturing to manufacture the acoustic impedance matching device 524 may lead to shorter development time as compared to manufacturing the acoustic impedance matching device 524 using machining. The use of additive manufacturing may also reduce manufacturing lead time as compared to manufacturing lead time using machining. Additive manufacturing also enables functionally graded acoustic impedance matching, which may improve performance of the acoustic impedance matching device 524. Additive manufacturing may also enable design of a tunable acoustic cover.

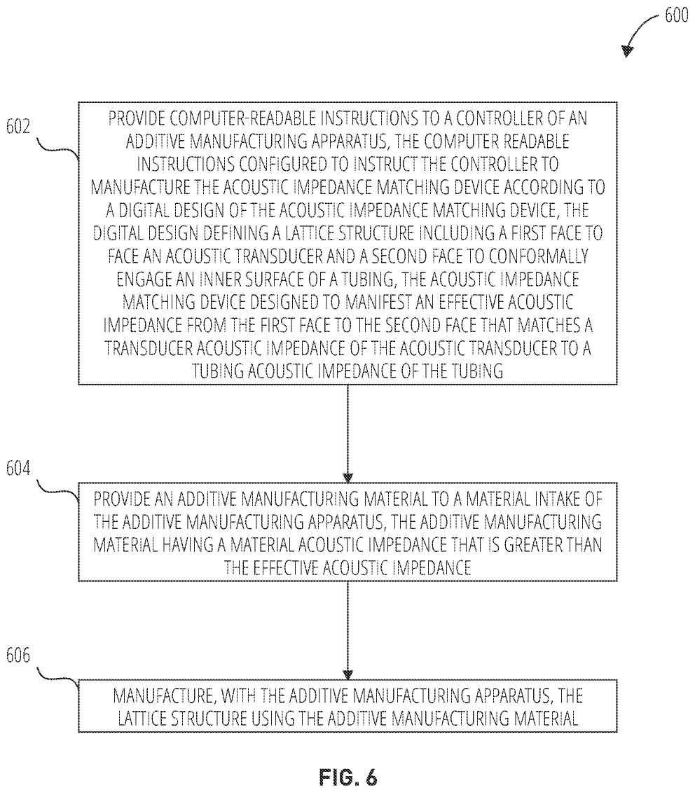

FIG. 6 is a flowchart illustrating a method 600 of manufacturing an acoustic impedance matching device, according to some embodiments. At operation 602 the method 600 includes providing computer-readable instructions to a controller of an additive manufacturing apparatus. The computer readable instructions are configured to instruct the controller to manufacture the acoustic impedance matching device according to a digital design of the acoustic impedance matching device. The digital design defines a lattice structure including a first face for facing an acoustic transducer and a second face to at least substantially conformally engage an inner surface of a tubing. The acoustic impedance matching device is designed to manifest an effective acoustic impedance from the first face to the second face that matches a transducer acoustic impedance of the acoustic transducer to a tubing acoustic impedance of the tubing.

At operation 604 the method 600 includes providing an additive manufacturing material to a material intake of the additive manufacturing apparatus. The additive manufacturing material has a material acoustic impedance that is greater than the effective acoustic impedance. In some embodiments the additive manufacturing material includes a metal. In some embodiments the additive manufacturing material includes a nickel-chromium-based alloy (e.g., Inconel® 718). In some embodiments the material acoustic impedance of the nickel-chromium-based alloy is substantially 40 megaRayl (MRayl).

At operation 606 the method 600 includes manufacturing, with the additive manufacturing apparatus, the lattice structure using the additive manufacturing material.

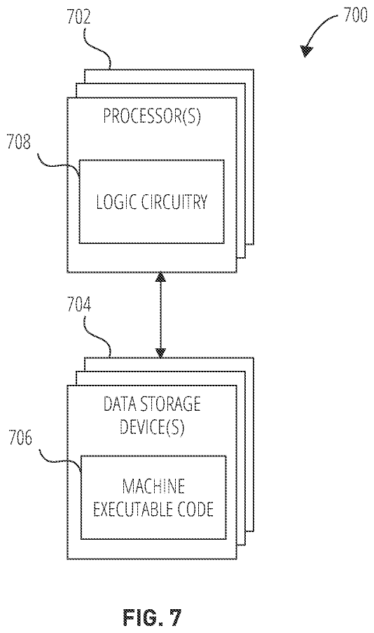

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 7 illustrates non-limiting examples of implementations of functional elements disclosed herein. In some embodiments, some or all portions of the functional elements disclosed herein may be performed by hardware specially configured for carrying out the functional elements.

FIG. 7 is a block diagram of circuitry 700 that, in some embodiments, may be used to implement various functions, operations, acts, processes, and/or methods disclosed herein. The circuitry 700 includes one or more processors 702 (sometimes referred to herein as “processors 702”) operably coupled to one or more data storage devices (sometimes referred to herein as “storage 704”). The storage 704 includes machine executable code 706 stored thereon and the processors 702 include logic circuitry 708. The machine executable code 706 includes information describing functional elements that may be implemented by (e.g., performed by) the logic circuitry 708. The logic circuitry 708 is adapted to implement (e.g., perform) the functional elements described by the machine executable code 706. The circuitry 700, when executing the functional elements described by the machine executable code 706, should be considered as special purpose hardware configured for carrying out functional elements disclosed herein. In some embodiments the processors 702 may be configured to perform the functional elements described by the machine executable code 706 sequentially, concurrently (e.g., on one or more different hardware platforms), or in one or more parallel process streams.

When implemented by logic circuitry 708 of the processors 702, the machine executable code 706 is configured to adapt the processors 702 to perform operations of embodiments disclosed herein. For example, the machine executable code 706 may be configured to adapt the processors 702 to perform at least a portion or a totality of the operations discussed for the controller 502 of FIG. 5. As a specific, non-limiting example, the machine executable code 706 may be configured to adapt the processors 702 to perform at least a portion of the method 600 of FIG. 6. As another specific, non-limiting example, the machine executable code 706 may be configured to adapt the processors 702 to control operation of the acoustic transducers 202a, 202b, 202c, 202d, 202e, and 202f of FIG. 2. As a further, non-limiting example, the machine executable code 706 may be configured to adapt the processors 702 to perform operation 412 of FIG. 4, determine one or more properties of the casing responsive to the reflected signal.

The processors 702 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine executable code 706 (e.g., software code, firmware code, hardware descriptions) related to embodiments of the present disclosure. It is noted that a general-purpose processor (may also be referred to herein as a host processor or simply a host) may be a microprocessor, but in the alternative, the processors 702 may include any conventional processor, controller, microcontroller, or state machine. The processors 702 may also be implemented as a combination of computing devices, such as a combination of a DSP and a microprocessor, a plurality of microprocessors, one or more microprocessors in conjunction with a DSP core, or any other such configuration.

In some embodiments the storage 704 includes volatile data storage (e.g., random-access memory (RAM)), non-volatile data storage (e.g., Flash memory, a hard disc drive, a solid state drive, erasable programmable read-only memory (EPROM), etc.). In some embodiments the processors 702 and the storage 704 may be implemented into a single device (e.g., a semiconductor device product, a system on chip (SOC), etc.). In some embodiments the processors 702 and the storage 704 may be implemented into separate devices.

In some embodiments the machine executable code 706 may include computer-readable instructions (e.g., software code, firmware code). By way of non-limiting example, the computer-readable instructions may be stored by the storage 704, accessed directly by the processors 702, and executed by the processors 702 using at least the logic circuitry 708. Also by way of non-limiting example, the computer-readable instructions may be stored on the storage 704, transferred to a memory device (not shown) for execution, and executed by the processors 702 using at least the logic circuitry 708. Accordingly, in some embodiments the logic circuitry 708 includes electrically configurable logic circuitry 708.

In some embodiments the machine executable code 706 may describe hardware (e.g., circuitry) to be implemented in the logic circuitry 708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments the machine executable code 706 may include an HDL, an RTL, a GL description, a mask level description, other hardware description, or any combination thereof.

In embodiments where the machine executable code 706 includes a hardware description (at any level of abstraction), a system (not shown, but including the storage 704) may be configured to implement the hardware description described by the machine executable code 706. By way of non-limiting example, the processors 702 may include a programmable logic device (e.g., an FPGA or a PLC) and the logic circuitry 708 may be electrically controlled to implement circuitry corresponding to the hardware description into the logic circuitry 708. Also by way of non-limiting example, the logic circuitry 708 may include hard-wired logic manufactured by a manufacturing system (not shown, but including the storage 704) according to the hardware description of the machine executable code 706.

Regardless of whether the machine executable code 706 includes computer-readable instructions or a hardware description, the logic circuitry 708 is adapted to perform the functional elements described by the machine executable code 706 when implementing the functional elements of the machine executable code 706. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. An acoustic impedance matching device, comprising:
a first face for facing an acoustic transducer;
a second face opposite the first face, the second face shaped to at least substantially conformally engage an inner surface of a tubing; and
a lattice structure between the first face and the second face, an effective acoustic impedance of the lattice structure at least substantially matching a transducer acoustic impedance of the acoustic transducer to a tubing acoustic impedance of the tubing, a material acoustic impedance of a material of the lattice structure greater than the effective acoustic impedance.

2. The acoustic impedance matching device of claim 1, wherein the lattice structure is a honeycomb lattice structure.

3. The acoustic impedance matching device of claim 1, wherein the lattice structure is one or more of a cubic lattice structure, an octet-truss lattice structure, a Kelvin cell lattice structure, a circular lattice structure, an octagonal lattice structure, a pyramidal lattice structure, a diamond lattice structure, a gyroid lattice structure, a Schwarz minimal surface lattice structure, or a Neovius surface lattice structure.

4. The acoustic impedance matching device of claim 1, wherein an effective density of the lattice structure increases from the first face to the second face.

5. The acoustic impedance matching device of claim 1, wherein the effective acoustic impedance is at least substantially a geometric mean of the tubing acoustic impedance and the transducer acoustic impedance.

6. The acoustic impedance matching device of claim 1, wherein the effective acoustic impedance is at least substantially 27 megaRayl (MRayl) and the material acoustic impedance is at least substantially 40 MRayl.

7. The acoustic impedance matching device of claim 1, wherein gaps between structures of the material within the lattice structure are filled with a filler material.

8. The acoustic impedance matching device of claim 7, wherein the filler material comprises at least one of an oil or an epoxy.

9. A method of manufacturing an acoustic impedance matching device, the method comprising:
providing computer-readable instructions to a controller of an additive manufacturing apparatus, the computer-readable instructions configured to instruct the controller to manufacture the acoustic impedance matching device according to a digital design of the acoustic impedance matching device, the digital design defining a lattice structure including a first face for facing an acoustic transducer and a second face to at least substantially conformally engage an inner surface of a tubing, the acoustic impedance matching device designed to manifest an effective acoustic impedance from the first face to the second face that at least substantially matches a transducer acoustic impedance of the acoustic transducer to a tubing acoustic impedance of the tubing;
providing an additive manufacturing material to a material intake of the additive manufacturing apparatus, the additive manufacturing material having a material acoustic impedance that is greater than the effective acoustic impedance; and
manufacturing, with the additive manufacturing apparatus and according to the computer-readable instructions, the lattice structure using the additive manufacturing material.

10. The method of claim 9, wherein the additive manufacturing material includes a metal.

11. The method of claim 9, wherein the additive manufacturing material includes a nickel-chromium-based alloy.

12. The method of claim 11, wherein the material acoustic impedance of the nickel-chromium-based alloy is at least substantially 40 megaRayl (MRayl).

13. A method of operating an acoustic impedance matching device, the method comprising:
applying an acoustic transducer to a first face of the acoustic impedance matching device, the acoustic transducer having a transducer acoustic impedance;
placing a second face of the acoustic impedance matching device into contact with an internal surface of a tubing, the second face opposite to the first face, the tubing having a tubing acoustic impedance that is mismatched to the transducer acoustic impedance;
at least substantially matching the transducer acoustic impedance to the tubing acoustic impedance with an effective acoustic impedance of the acoustic impedance matching device that is less than a material acoustic impedance of a material of the acoustic impedance matching device, a lattice structure of the material of the acoustic impedance matching device reducing the effective acoustic impedance of the acoustic impedance matching device relative to the material acoustic impedance;
transmitting an acoustic signal from the acoustic transducer to a casing through the acoustic impedance matching device and the tubing;
receiving a reflected acoustic signal; and
determining one or more properties of the casing responsive to the reflected acoustic signal.

14. The method of claim 13, wherein applying the acoustic transducer to the first face of the acoustic impedance matching device comprises applying a piezo crystal having the transducer acoustic impedance of at least substantially 15 to 20 megaRayl (MRayl) to the first face of the acoustic impedance matching device.

15. The method of claim 13, wherein placing the second face of the acoustic impedance matching device into contact with the internal surface of the tubing includes placing the second face of the acoustic impedance matching device into contact with the internal surface of a metal tubing.

16. The method of claim 13, wherein placing the second face of the acoustic impedance matching device into contact with the internal surface of the tubing includes placing the second face of the acoustic impedance matching device into contact with the internal surface of a steel tubing.

17. The method of claim 13, wherein placing the second face of the acoustic impedance matching device into contact with the internal surface of the tubing includes placing the second face of the acoustic impedance matching device into contact with the internal surface of a polymer tubing.

18. The method of claim 13, wherein transmitting the acoustic signal from the acoustic transducer to the casing through the acoustic impedance matching device and the tubing includes transmitting the acoustic signal to a casing through the acoustic impedance matching device and a steel tubing.

19. The method of claim 13, further comprising sealing a wellbore responsive to a determination that the one or more properties of the casing are satisfactory.

20. The method of claim 13, further comprising repairing a wellbore responsive to a determination that the one or more properties of the casing are not satisfactory.
